(19) United States
(12) Patent Application Publication
(10) Pub. No.: US 2007/0153088 A1
(43) Pub. Date: Jul. 5, 2007

(54) System and method for testing a cable television system

(76) Inventors: Paul Hales, Fenton, MI (US); Charles Hanchett, Columbus, OH (US); Wyatt South, Marion, OH (US); Daun Yeagley II, Wilmington, OH (US); Jeremy Duby, Clio, MI (US)

Correspondence Address: HARNESS, DICKEY & PIERCE, P.L.C., P.O. BOX 828, BLOOMFIELD HILLS, MI, 48303, US

(21) Appl. No.: 11/322,182

(22) Filed: Dec. 29, 2005

(51) Int. Cl. H04N 17/00; H04N 17/02

(52) U.S. Cl. 348/181

(57) ABSTRACT

An improved and cost effective method is provided for testing the head end of a cable television system. The method includes: configuring the head end with a test signal generator; configuring the test signal generator with a phone interface mechanism; configuring a spectrum analyzer at a test point along the cable which is remotely located from the head end; initiating the testing operation from the test point by the technician without the intervention of a different technician at the head end; and capturing test data resulting from the testing operation using the spectrum analyzer.

### FIELD OF THE INVENTION

The present invention relates to an improved and cost effective system and method for testing a cable television system.

### BACKGROUND OF THE INVENTION

Twice each year (usually during January or February, and again in July or August) the Federal Communication Commission (FCC) requires every cable system with 1,000 or more subscribers to conduct comprehensive technical inspections. These inspections are commonly referred to as “Proof-of-Performance” tests. The proof-of-performance report, produced by the cable operator based on the tests it conducts, contains the technical data that shows whether the local cable operator is meeting its federal picture and sound quality obligations. The purpose of the testing is to determine whether a particular cable system complies with the technical standards established by the FCC, and to officially document the cable system's compliance (or non-compliance) with those rules. The FCC rules also require the cable operator to disclose how it conducted the tests, the equipment used, calibration data, and qualification data of those persons involved in the testing.

Conventional proof-of-performance testing typically involves multiple technicians. A technician is needed to operate test equipment residing at the head end and a different technician is needed to configure and monitor test equipment disposed at each of the remote test points in the cable system. The use of multiple technicians introduces unnecessary expense into the testing process. Therefore, it is desirable to provide an improved and cost effective system and method for testing a cable television system

### SUMMARY OF THE INVENTION

An improved and cost effective method is provided for testing the head end of a cable television system. The method includes: configuring the head end with a test signal generator; configuring a spectrum analyzer at a test point along the cable which is remotely located from the head end; initiating the testing operation from the test point by the technician without the intervention of a different technician at the head end; and capturing test data resulting from the testing operation using the spectrum analyzer.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a block diagram of an exemplary system for testing a cable television system;

FIG. 2 is a schematic of an exemplary interface circuit between a phone and a test signal generator;

FIG. 3 is a diagram depicting how to configure a spectrum analyzer for distortion testing;

FIG. 4 is a graph illustrating exemplary test results from a frequency response test performed at a head end of the cable television system;

FIG. 5 is an exemplary report format for frequency testing performed at the head end; and

FIG. 6 is an exemplary summary compliance report for head end testing.

### DETAILED DESCRIPTION OF THE PREFERRED EMBODIMENTS

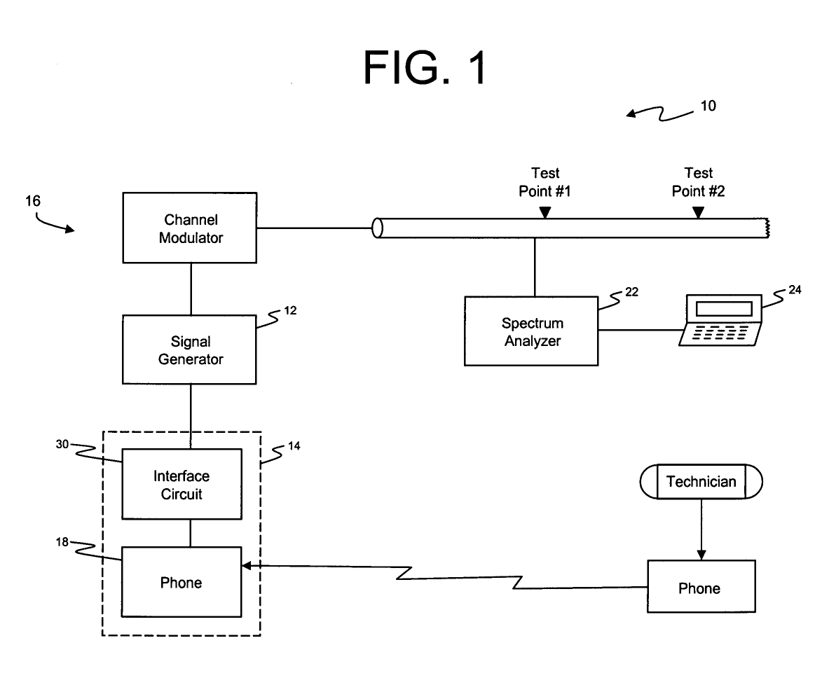

FIG. 1 illustrates an exemplary system 10 for testing a cable television system according to the principles of the present invention. The system is generally comprised of a test signal generator 12 and a test initiation mechanism 14 disposed at the head end 16 as well as a spectrum analyzer 22 and a test examiner 24 disposed at one or more test points with the system.

The test signal generator 12 is generally configured to perform testing operations on one or more channels carried by a cable which is fed by the head-end. In operation, the test signal generator 12 interfaces with the head end 16 to introduce test signals into the cable. Although not limited hereto, the Cybertek examiner from ComSonics is an exemplary embodiment of such a test signal generator. In this exemplary embodiment, the Cybertek examiner is interfaced with the modulators for the channels to be tested. More specifically, switches from the Cybertek examiner are connected via RF and CAT-5 cables to the video IF loop and video RF inputs of the modulators. Even though Cybertek examiner may not be used during initial testing, the switch connection must be in place. The switch will introduce a loss of about 3 dB of the signal level and thus the modulator output must be adjusted to the proper output level to maintain flatness across the entire analog bandwidth during testing.

The test signal generator 12 also interfaces with a test initiation mechanism 14 which enables a technician residing at a test point remote from the head end 16 to initiate testing operations. The test initiation mechanism 14 is further defined as a telephone 18 and a phone interface circuit 30. Briefly, a test operation is initiated by a technician placing a call to the telephone 18. The ring voltage generated by the telephone is converted by the phone interface circuit into an input signal for the test signal generator. The input signal is in turn used to actuate a switch internal to the test signal generator 12, thereby simulating a technician pressing a corresponding button provided on the control panel of the test signal generator 12. While the following description is provided with reference to the use of a telephone, it is readily understood that the broader aspects of this disclosure contemplate other types of wireless transmission mechanisms (e.g., RF-based or satellite) for initiating the testing operations.

A more detailed description of an exemplary test initiation mechanism is provided below. To interface with the ring signal, the telephone is modified to provide a phono jack tied into the ringer output of the phone. When a call is received, the phone outputs a ringer voltage of approximately 50 mV from this modified data port. Although a portable cellular phone is preferred, it is readily understood that the ring signal from any type of phone may be used as input to the interface circuit.

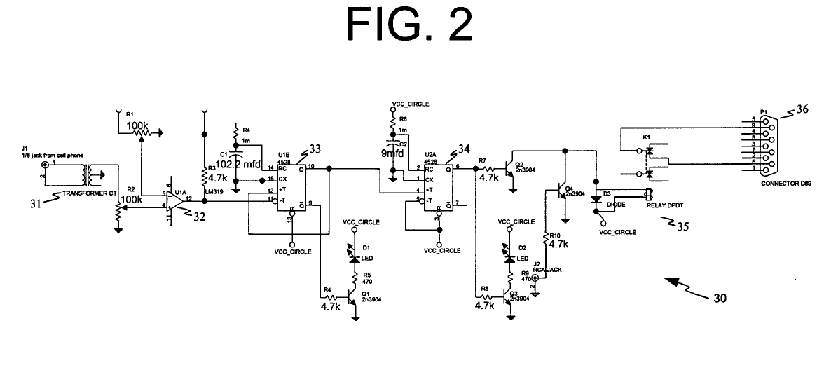

Referring to FIG. 2, the ringer voltage serves as the input to the phone interface circuit 30. More specifically, the voltage is applied to a step-up transformer 31, thereby increasing the voltage level to a more useable 40 mV. The output signal from the transformer 31 is then processed through a voltage divider circuit with the purpose of setting an input level to a comparator 32 (e.g., LM319 High Speed Comparator). The other input to this comparator 32 is preset via a separate voltage divider to this same expected level. When the cell phone ring signal is detected, the output of the comparator 32 switches from a high level to a low level. This action triggers the first of two monostable multivibrators. The first multivibrator 33 is set for a 23 second time delay in order to prevent a false trigger from a short ring duration or a second ring from the phone. The first multivibrator will then trigger the second monostable 34 which is set for a 1 second time delay. Lastly, the output of the second monostable 34 will close the normally open contacts of a relay 35. The output contacts of this relay 35 are connected through a cable to pins 5 and 9 of a RS232 connector 36. In this exemplary embodiment, the Cybertek examiner provides a RS232 -compatible interface port, such that the RS232 connector from the interface circuit may be electrically coupled to the examiner. It is readily understood that within the broader aspects of the present invention other circuit configurations may be employed to convert the ring signal to an input signal for the test signal generator.

To enable the test initiation to be controlled by the phone interface circuit, modification of the Cybertek examiner is also required. In particular, the RS232 interface port is disconnected from a main control board. An internal cable connection or special interface board is used to connect pins 5 and 9 from the RS232 interface port directly to the test initiation switch inside the test equipment. Thus, this modification does not prevent manual operation of the test equipment from its external panel. It is noteworthy that the ring voltage initiates the test operation, thereby avoiding any surcharges which may be assessed for connecting the call.

Before proceeding to remote test points, a technician will conduct various tests at the head end. To do so, a spectrum analyzer 22 is connected at a test output of the head end. In an exemplary embodiment, the spectrum analyzer is the Hewlett-Packard 8591C spectrum analyzer configured with a factory installed optional serial interface board, monitor personality software and measurement personality software. It is readily understood that most commercially available spectrum analyzers are equipped with such software programs. To further automate the testing process, the spectrum analyzer is also connected via a RS232 null modem serial connection to a computing device. The computing device is configured with custom software which cooperatively operates with the spectrum analyzer to conduct various tests as required by the FCC.

For example, a frequency analysis is performed for each channel frequency output at the head end by establishing the start and stop bandwidth to match the respective low and high analog frequency utilized by the cable system. The spectrum analyzer is configured with the applicable measurement function as well as receptive of commands which initiate the function. The custom software residing on the computing device initiates the applicable measurement function. To do so, the custom software first configures a communication channel between the computing device and the spectrum analyzer, including opening a channel and setting parameters such as baud rate, parity, character length, and stop bit. The custom software then initiates the measurement function using a pre-defined command sent over the communication channel to the spectrum analyzer.

Once the frequency analysis has been completed, the test result data are transferred in a comma delimited file format from the spectrum analyzer to the computing device. To determine if significant discrepancies are present, the technician may inspect the file contents and, if necessary, perform any needed corrective action. Following any needed corrective action, the testing is repeated. Once satisfactory results have been achieved, the resulting test data file is moved to an applicable directory on the computing device for subsequent reporting as will be further described below.

In a similar manner, the test management software cooperatively operates with the measurement personality software to measure the chrominance luminance delay, the differential gain and differential phase. Although these three tests may be performed on each channel, they are preferable only performed on a select number of representative channels as provided by the FCC regulations. The test data from these tests is likewise transferred from the spectrum analyzer to the computer for subsequent reporting.

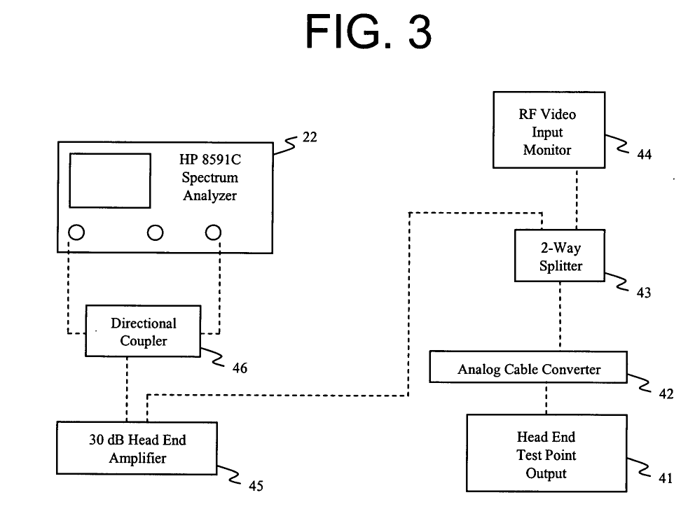

Distortion testing is also performed at the head end. The spectrum analyzer 22 is reconfigured to receive a channel signal from the test output port 41 via an analog cable converter 42 as shown in FIG. 3. Output from the analog cable converter 42 is input to a two-way splitter 43 so that the channel signal may be input to an RF monitor 44. The other output from the splitter 43 is connected through an amplifier 45 and directional coupler 46 to the spectrum analyzer 22. Attenuators are added as necessary to obtain a signal level of 28 dBmV plus or minus 2 dB at the input of the spectrum analyzer. While the use of an analog converter is required by applicable FCC regulations, it is envisioned that distortion testing may proceed without the converter.

Distortion testing begins with a system frequency response graph and a low frequency disturbance test (also referred to as a “hum” test). The system frequency response graph is a screen capture of the video carrier level off the spectrum analyzer that is performed over the entire analog bandwidth of the cable system. In contrast, the low frequency disturbance test only needs to be performed on a single channel. This channel is typically in the lower bandwidth, such as channel 2, 3 or 4. This test locates undesired modulation of the television visual carrier by power-line frequency, its harmonics, or other low frequency disturbances. Remaining distortion tests are channel specific and require a test signal to be introduced into the channel by the test signal generator. In the exemplary embodiment, the Cybertek examiner is pre-programmed to introduce a test signal into each of the channels being tested.

To initiate testing, the technician may actuate the applicable start button on the Cybertek examiner. Alternatively, since the Cybertek examiner may be spatially separated from the test output port of the head end and thus separated from the spectrum analyzer, the technician may initiate testing using the test initiation mechanism described above. In other words, the technician places a call to the telephone associated with the test initiation mechanism. The technician will know the testing is underway when an in-channel response sweep trace from the test equipment appears on the display of the spectrum analyzer.

For each channel being tested, the test equipment will introduce a test signal into the channel for a predefined period of time. When establishing a test schedule, sufficient time must be allowed for the spectrum analyzer to perform the requisite measurements. Duration for each test signal may range from 5 to 255 seconds. Typical measurement times are as follows: in-band flatness test is 20 seconds; carrier to noise test is 30 seconds; composite triple beat, and composite second order or any other coherent disturbance test is 120 seconds. The test equipment is pre-configured with a suitable test sequence.

During the test sequence, the test management software cooperatively operates with the measurement personality software of the spectrum analyzer to collect measurement data. Exemplary tests measurements include an in-channel response measure, a carrier to noise measure, composite triple beat measure and a coherent disturbance measure. In the case of the coherent disturbance test, the technician may be required to observe the trace results on the spectrum analyzer and adjust the analyzer to focus its measurement on the most significant coherent disturbance; otherwise, the automated test sequence is completed without technician intervention. Upon completing testing of a given channel, the technician may also be required to change the channel output of the analog cable converter to coincide with the channel being tested by the Cybertek examiner. Lastly, the collected test data is transferred from the spectrum analyzer to the computer for subsequent reporting.

The cable system must also be tested at a number of test points remote from the head end. For instance, a twenty-four hour test is typically performed using an RF signal level meter. The meter is connected at each test point using one-hundred feet of RG-6 coaxial cable. The meter is operable to record audio and video signal levels across the entire bandwidth four times within a 24 hour period. Once the test is complete, the technician retrieves the meter from its test point and transfers the collected data to the computer.

Before moving to another test point, the technician may also conduct distortion testing at the test point. The spectrum analyzer is again configured in the manner shown in FIG. 3. One or more of the different distortion tests may be performed in the same manner as described above. In this case, the Cybertek examiner is preferably initiated using the test initiation mechanism, thereby eliminating the need for a second technician to conduct testing at the remote test points. Once testing has been completed at all of the required test points, the technician returns to the head end to retrieve the Cybertek examiner.

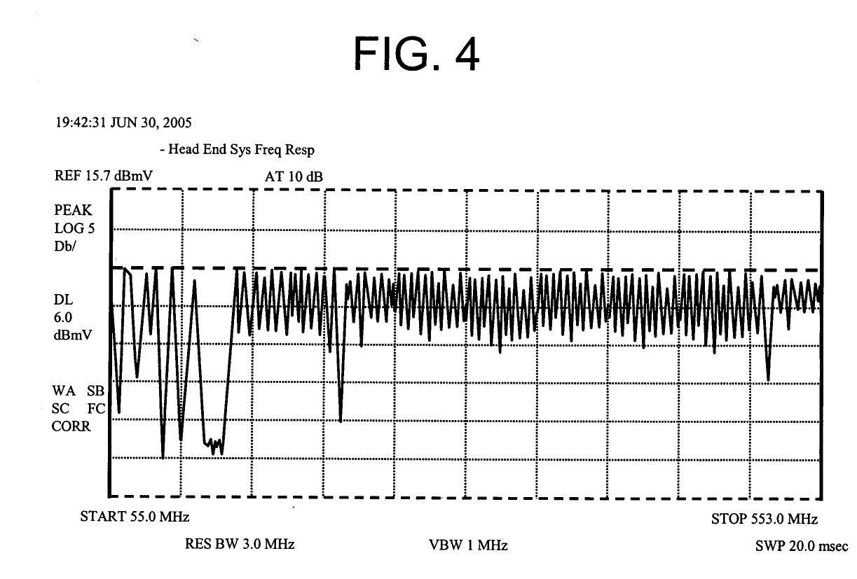

Lastly, test results are compiled and reported to the cable system operator. In a preferred embodiment, test results are reported in a booklet which includes reports and/or test results for each of the tests conducted on the cable system. In most instances, test results are reported in table form as further described below. In some instances, the test results may be reported in graph form. For instance, results from the frequency response test are reported as shown in FIG. 4. The booklet may further include a report on the system test parameters and an engineering statement as required by FCC regulations.

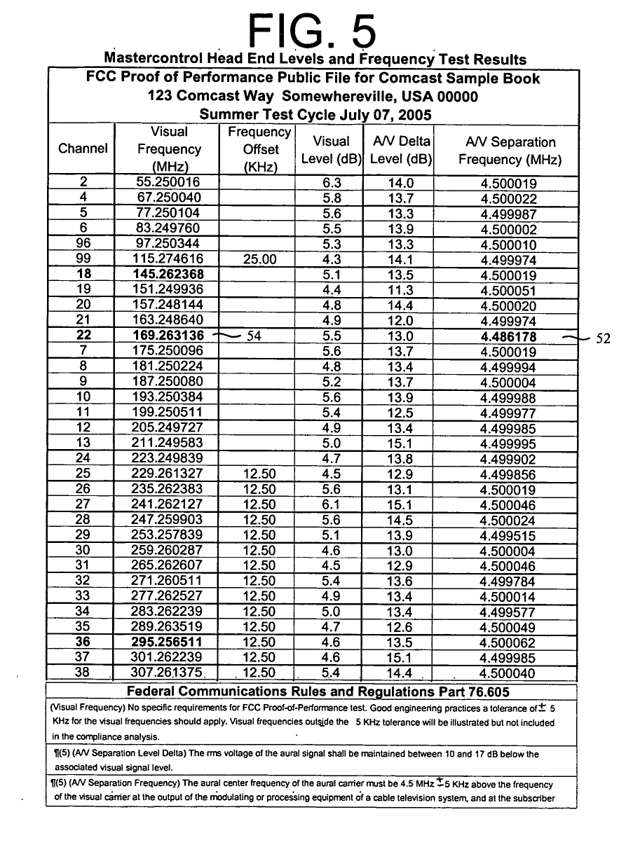

FIG. 5 illustrates an exemplary report for the frequency testing performed at the head end. Raw test data is provided for each channel. In addition, the test data undergoes a compliance analysis to determine if the applicable FCC requirements have been meet. Test data which is not compliant with an applicable FCC requirement is preferably indicated by a font change (e.g., color, style, size, etc.). In this exemplary embodiment, test data that is not FCC compliant is indicated at 52 by a red color font. Likewise, test data which does not meet good engineering practices may also be brought the operator's attention by bold font as shown at 54. The applicable FCC requirements are preferably provided at the bottom of the report. Similar reports are provided for distortion testing performed at the head end and at each of the test points as well as for the twenty-four hour testing performed at each of the test points.

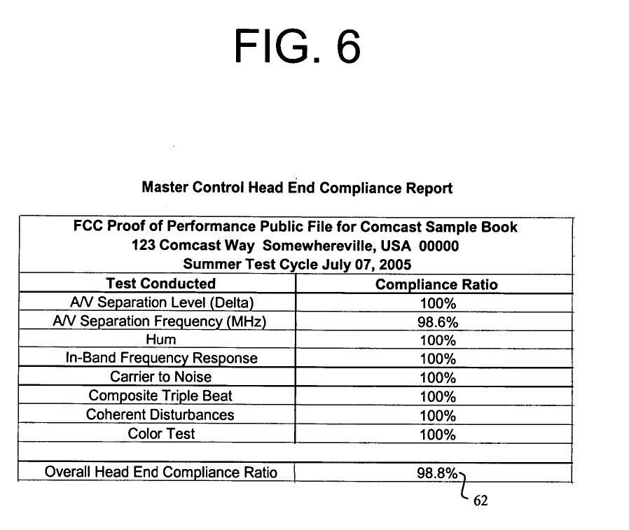

Summary compliance reports may also be compiled. FIG. 6 illustrates an exemplary compliance report for head end testing. In this report, a compliance percentage is reported for each type of test that was conducted. The data may be further summarized to provide an overall compliance ratio for all of the tests conducted at the head end as indicated at 62.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of testing a head end of a cable television system, comprising:
configuring the head end with a test signal generator, wherein the test signal generator is configured by a technician to perform a testing operation of one or more channels carried by a cable which is feed by the head-end;
configuring a spectrum analyzer at a test point along the cable which is remotely located from the head end, wherein the spectrum analyzer is configured to capture test data resulting from a testing operation of the test signal generator;
initiating the testing operation from the test point by the technician without the intervention of a different technician at the head end; and
capturing test data resulting from the testing operation using the spectrum analyzer.

2. The method of claim 1 wherein initiating the testing operation further comprises using a ring signal resulting from a call placed by the technician from the test point location.

3. The method of claim 1 wherein configuring the head end further comprises interfacing a telephone with the test signal generator.

4. The method of claim 3 wherein initiating the testing operation further comprises:
making a call from the test point to the telephone;
converting a ring signal caused by the call into an input signal for the test signal generator; and
initiating the testing operation in response to the input signal.

5. The method of claim 1 wherein capturing test data further comprises selecting a measure from the group consisting of an in-channel response measure, carrier to noise measure, composite triple beat measure and coherent disturbance measure.

6. The method of claim 1 further comprises compiling the test data into a report at the test point and transmitting the report via a wireless communication link to an entity remotely located from the test point.

7. The method of claim 6 wherein the test data for the report is provided in compliance with a government communications regulation.

8. The method of claim 7 wherein applicable government communication regulations accompany the test data on the report.

9. The method of claim 6 further comprises highlighting test data that is not in compliance with a government communication regulation.

10. The method of claim 6 further comprises highlighting test data that is not in accordance with conventional engineering practice.

11. The method of claim 1 further comprises configuring a signal level meter at the test point prior to configuring the spectrum analyzer and recording audio and video signal levels across the bandwidth supported by the cable at period time intervals.

12. The method of claim 1 further comprises
configuring the spectrum analyzer at a different test point along the cable which is remotely located from the head end, wherein the spectrum analyzer is configured to capture test data resulting from a testing operation of the test signal generator;
initiating a second testing operation from the different test point by the technician without the intervention of a different technician at the head end; and
capturing test data resulting from the second testing operation using the spectrum analyzer.

13. The method of claim 1 further comprises configuring the spectrum analyzer at the head end and conducting a frequency analysis of each of the channels output by the head end.

14. The method of claim 1 further comprises configuring the spectrum analyzer at the head end and conducting distortion testing on select channels output by the head end.

15. A method for remotely initiating a test at a head end of a cable television system, comprising:
connecting a test signal generator to the head end;
connecting a phone interface mechanism to the signal generator;
connecting a spectrum analyzer at a test point remote from the head end;
placing a call from the test point to a telephone residing at the head end;
converting a ring signal caused by the call to an input signal for the test signal generator; and
initiating a test by the test signal generator based on the input signal.

16. The method of claim 15 further comprises capturing test data resulting from the testing operation using the spectrum analyzer.

17. The method of claim 1 wherein capturing test data further comprises selecting a measure from the group consisting of an in-channel response measure, carrier to noise measure, composite triple beat measure and coherent disturbance measure.

18. The method of claim 1 further comprises compiling the test data into a report at the test point and transmitting the report via a wireless communication link to an entity remotely located from the test point.

19. The method of claim 18 wherein the test data for the report is provided in compliance with a government communications regulation.

20. The method of claim 19 wherein the applicable government communication regulations accompany the test data on the report.

21. The method of claim 18 further comprises highlighting test data that is not in compliance with a government communication regulation.

22. The method of claim 18 further comprises highlighting test data that is not in accordance with conventional engineering practice.

23. The method of claim 15 further comprises
configuring the spectrum analyzer at a different test point along the cable which is remotely located from the head end, wherein the spectrum analyzer is configured to capture test data resulting from a testing operation of the test signal generator;
initiating a second testing operation from the different test point by the technician without the intervention of a different technician at the head end; and
capturing test data resulting from the second testing operation using the spectrum analyzer.
